(19) United States
(12) Patent Application Publication
(10) Pub. No.: US 2009/0153456 A1
(43) Pub. Date: Jun. 18, 2009

(54) Method for generating over-drive data

(76) Inventors: Pei-Ting Tsai, Taitung City (TW); Wen-Min Lu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/127,781

(22) Filed: May 27, 2008

(30) Foreign Application Priority Data
Dec. 17, 2007 (TW) 096148246

(51) Int. Cl. G09G 3/36

(52) U.S. Cl. 345/89

(57) ABSTRACT

A method for generating over-drive data includes storing a reduced over-drive table and a predetermined weighting table, finding first and second reference values from the reduced over-drive table according to received previous current pixel values, finding first and second weighting values from the predetermined weighting table according to the received current pixel value, and generating a corresponding over-drive data according to the first and the second reference values, and the first and the second weighting values.

### BACKGROUND OF THE INVENTION

1. Field of the Invention

The present invention relates to a method for generating over-drive data, and more particularly, to a method that calculates pixel values from a reduced over-drive table for generating over-drive data.

2. Description of the Prior Art

Please refer to FIG. 1. FIG. 1 is a diagram illustrating a raw over-drive table (without reduction). To increase response time of a liquid crystal display (LCD), when driving the LCD, an over-driving method is employed. The over-drive pixel value is obtained by looking it up in the table in FIG. 1. As shown in FIG. 1, F1 represents a predetermined previous pixel value (gray level value of a pixel in a previous frame), and F2 represents a predetermined current pixel value (gray level value of the pixel in the current frame). If the LCD has 256 gray levels (8 bits) for variation of one primary color, e.g. red, green, and blue, the corresponding over-drive table would be 256×256×256 bits (32 Kbytes) large, which is too big to store in a normal driving chip of the LCD.

Please refer to FIG. 2. FIG. 2 is a diagram illustrating a reduced over-drive table. As shown in FIG. 2, the resolution of the table in FIG. 2 is reduced from the table in FIG. 1, thereby abandoning some of the over-drive pixel values. For example, when in the area constructed by the session of the predetermined previous pixel values 0 to 32 and the session of the predetermined current pixel values 32 to 64, the over-drive pixel values are all to be “0.” Thus, the table in FIG. 2 is reduced to 8×8×256 bits (64 bytes) large, and is obviously smaller than the table in FIG. 1. However, the reduction of the table in FIG. 2 results in insufficient over-drive functionality, overly long response time, and distortion of the displayed frame.

### SUMMARY OF THE INVENTION

The present invention provides a method for generating over-drive data. The method comprises (a) storing a reduced over-drive table and predetermined weighted table; (b) finding a first reference value and a second reference value from the reduced over-drive table according to a previous pixel value and a current pixel value; (c)

finding a first weighted value and a second weighted value from the predetermined weighted table according to the current pixel value; and (d) generating the over-drive data according to the first reference value, the second reference value, the first weighted value, and the second weighted vale.

The present invention further provides a generating device for generating over-drive data according to a previous pixel value and a current pixel value. The generating device comprises a storing device for storing a reduced over-drive table and a predetermined weighted table; a reference value generating device coupled to the storing device for finding a first reference value and a second reference value from the reduced over-drive table according to the previous pixel value and the current pixel value; a weighted value generating device coupled to the storing device for finding a first weighted value and a second weighted value from the predetermined weighted table according to the current pixel value; and a calculating device coupled to the reference value generating device and the weighted value generating device for generating the over-drive data according to the first reference value, the second reference value, the first weighted value, and the second weighted value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a raw over-drive table.

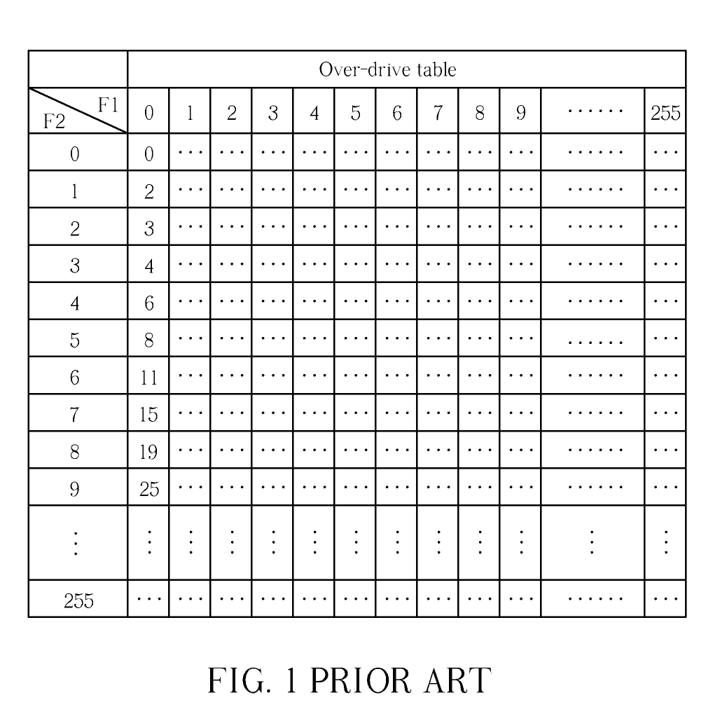

FIG. 2 is a diagram illustrating a reduced over-drive table of the prior art.

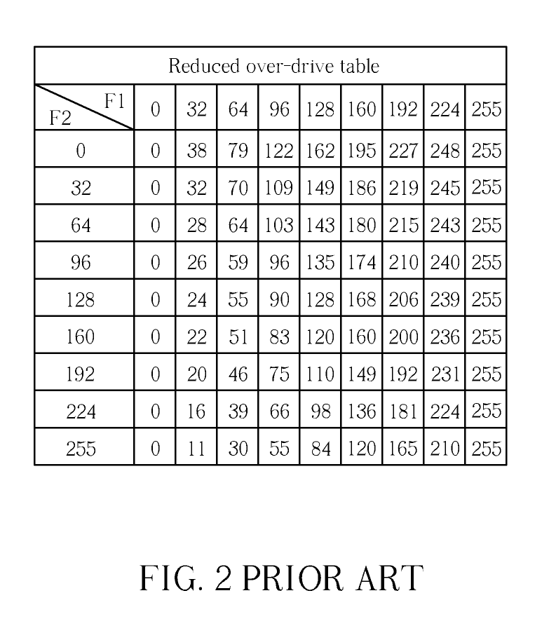

FIG. 3 is a diagram illustrating the reduced over-drive table of the present invention.

FIG. 4 is a diagram illustrating the predetermined weighted value table of the present invention.

FIG. 5 is a flowchart illustrating the method for generating over-drive pixel values of the present invention.

FIG. 6 is a diagram illustrating the generating device for generating over-drive data of the present invention.

### DETAILED DESCRIPTION

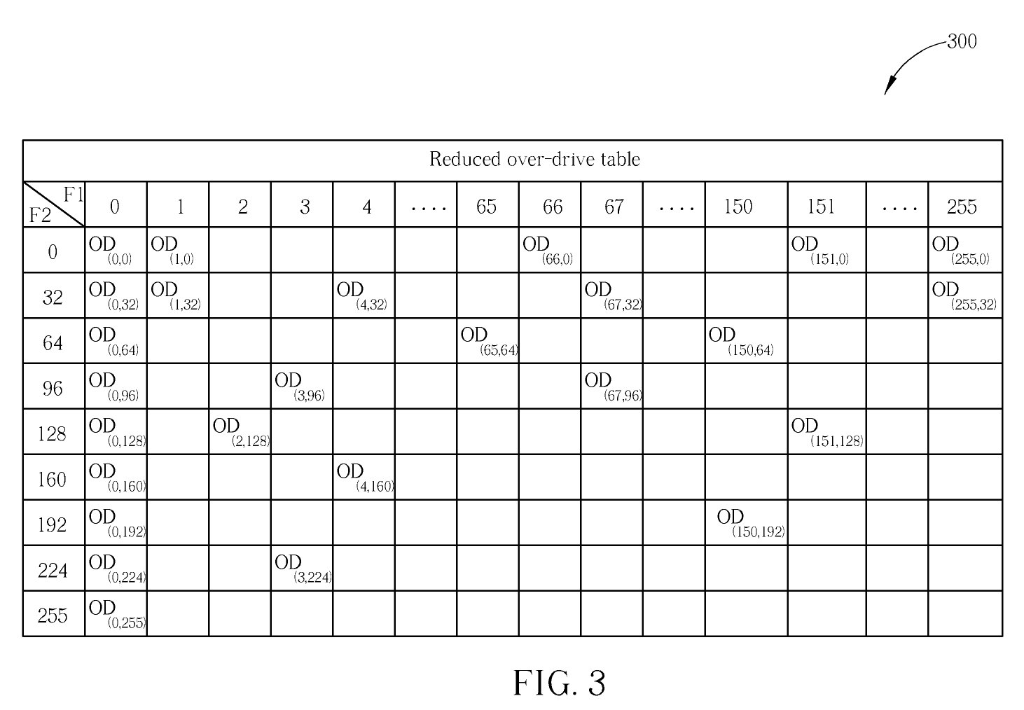

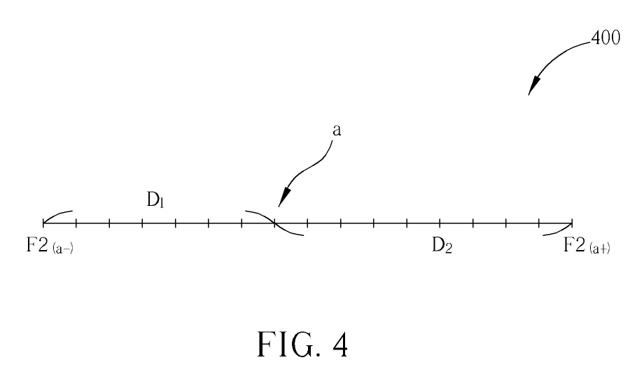

Please refer to FIG. 3 and FIG. 4. FIG. 3 is a diagram illustrating the reduced over-drive table 300 of the present invention. FIG. 4 is a diagram illustrating the predetermined weighted value table 400 of the present invention. As shown in FIG. 3, the reduced over-drive table 300 is an array constructed by a set of predetermined previous pixel values (F1) and a set of predetermined current pixel values (F2). The over-drive table 300 of the present invention only reduces the resolution of the current pixel values (F2) to reduce the size of the over-drive table. That is, the resolution of the current pixel values is reduced from 255 to 8 (8 bits to 3 bits). In this way, the over-drive table 300 is smaller, and sized at 256×256×8 bits.

As shown by the over-drive table 300, the corresponding over-drive pixel value is OD_{(0,0)} when the predetermined previous pixel value is “0” and the predetermined current pixel value is “0”; the corresponding over-drive pixel value is OD_{(1,32)} when the predetermined previous pixel value is “1” and the predetermined current pixel value is “32”; the corresponding over-drive pixel value is OD_{(255,32)} when the predetermined previous pixel value is “255” and the predetermined current pixel value is “32”, and so on. In this way, the received current pixel value can be over-driven by looking it up in the over-drive table 300 according to the received previous pixel value and the received current pixel value. For example, when the received previous pixel value (X−1) is “0”, and the received current pixel value X is “32”, the corresponding over-drive pixel value looked up from the over-drive table 300 is OD_{(0,32)}, and the over-drive pixel value OD_{(0,32)} is used to drive the LCD.

When the received current pixel value X is not just the same as any one of the predetermined current pixel values (such as 0, 32, 64, 96, 128, 192, 224, and 255) shown in the F2 session of the over-table 300, for example, if the received current pixel value X is “44”, the present invention utilizes the predetermined weighted value table 400 in FIG. 4 to calculate an appropriate over-drive pixel value for the received current pixel value. Assuming the received current pixel value X is “a”, then the received current pixel value X “a” certainly falls in the interval between the predetermined current pixel values F2₍ₐ₋₎ and F2₍ₐ₊₎. For example, if the received current pixel value X is “44” and the received previous pixel value (X−1) is “0”, then the received current pixel value X “a” falls in the interval between the predetermined current pixel values F2₍₄₄₋₎ and F2₍₄₄₊₎, wherein the predetermined current pixel values F2₍₄₄₋₎ and F2₍₄₄₊₎ are respectively “32” and “64”. Therefore, the corresponding over-drive pixel value OD_{(44,0)} in the current frame is calculated by weighting the over-drive pixel values OD_{(32,0)} and OD_{(64,0)} with respective weighted values. More particularly, when the value of the received current pixel X is “a”, the difference between the received current pixel value X of “a” and the predetermined current pixel value F2₍ₐ₋₎ is D₁, which equals (a−F2₍ₐ₋₎), and the difference between the current pixel value X of “a” and the predetermined current pixel value F2₍ₐ₊₎ is D₂, which equals (F2₍ₐ₊₎−a). Thus, the weighted value P₁ between the received current pixel value X of “a” and the predetermined current pixel value F2₍ₐ₋₎ equals (a−F2₍ₐ₋₎)/(F2₍ₐ₊₎−F2₍ₐ₋₎), and the weighted value P₂ between the received current pixel value X of “a” and the predetermined current pixel value F2₍ₐ₊) equals (F2₍ₐ₊₎−a)/(F2₍ₐ₊₎−F2₍ₐ₋₎).

In this way, when the received previous pixel value (X−1) is “b” and the received current pixel value X is “a”, the corresponding predetermined current pixel vales F2₍ₐ₋₎ and F2₍ₐ₊₎ can be found in the over-drive table 300. Next, the over-drive pixel value OD_{(b,a-)} can be found in the over-drive table 300 according to the predetermined current pixel value F2₍ₐ₋₎ and the predetermined previous pixel value of “b”, and the over-drive pixel value OD_{(b,a+)} can be found in the over-drive table 300 according to the predetermined current pixel value F2₍ₐ₊₎ and the predetermined previous pixel value of “b”. Then, the over-drive pixel value OD_{(b,a)} for the pixel to display in the current frame can be obtained by the equation: OD_{(b,a)}=P₁×OD_{(b,a-)}+P₂×OD_{(b,a+)}.

Hence, as described above, when the received previous pixel value (X−1) is “b” and the received current pixel value X is “a”, the corresponding over-drive pixel value OD_{(b,a)} for the pixel displaying in the current frame can be obtained according to the following 3 equations:

P₁=(a−F2₍ₐ₋₎)/(F2₍ₐ₊₎−F2₍ₐ₋₎) (1)

P₂=(F2₍ₐ₊₎−a)/(F2₍ₐ₊₎−F2₍ₐ₋₎) (2)

OD_{(b,a)}=P₁×OD_{(b,a-)}+P₂×OD_{(b,a+)} (3)

The reduced over-drive table 300 is an exemplary embodiment of the present invention, and any other reduced over-drive table can be applied and designed as desired.

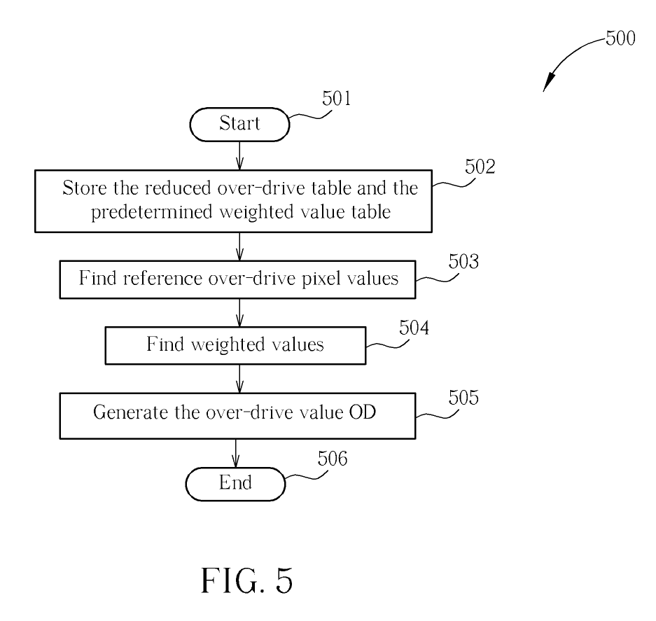

Please refer to FIG. 5. FIG. 5 is a flowchart illustrating the method 500 for generating over-drive pixel values with calculation of the over-drive table 300 of the present invention. It is assumed that the received previous pixel value (X−1) is “b”, the received current pixel value X is “a”, and the corresponding over-drive pixel value is OD_{(b,a)}. The steps are described as follows:

Step 501: Start;

Step 502: Store the reduced over-drive table 300 and the predetermined weighted value table 400;

Step 503: Find reference over-drive pixel values OD_{(b,a+)} and OD_{(b,a-)} according to the received previous pixel value (X−1) of “b” and the received current pixel value X of “a”;

Step 504: Find weighted values P₁ and P₂ according to the received current pixel value X of “a”;

Step 505: Generate the over-drive value OD_{(b,a)} according to the reference over-drive values OD_{(b,a-)} and OD_{(b,a+)} and the weighted values P₁ and P₂; and

Step 506: End.

Step 504 generates the weighted values P₁ and P₂ according to the equations (1) and (2). Step 505 generates the desired over-drive value according to the equation (3).

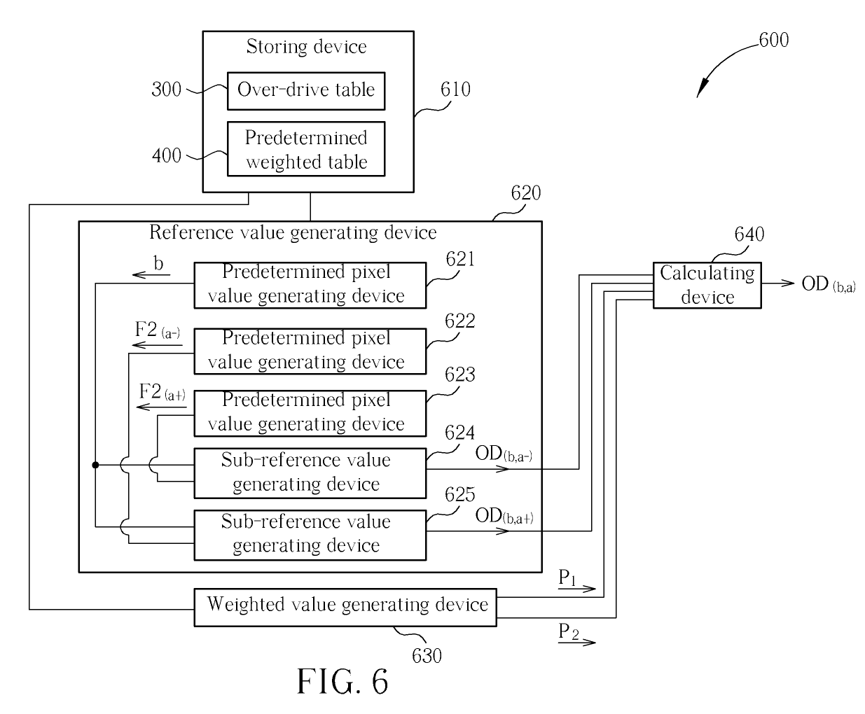

Please refer to FIG. 6. FIG. 6 is a diagram illustrating the generating device 600 for generating the over-drive data of the present invention. As shown in FIG. 6, the generating device 600 comprises a storing device 610, a reference value generating device 620, a weighted value generating device 630, and a calculating device 640.

The storing device 610 is disposed for storing the reduced over-drive table 300 and the predetermined weighted value table 400.

The reference value generating device 620 is coupled to the storing device 610 for receiving the received previous pixel value (X−1) and the received current pixel value X, and finding the corresponding reference over-drive values OD_{(b,a-)} and OD_{(b,a+)}. The reference value generating device 620 comprises predetermined pixel value generating devices 621, 622, and 623, and sub-reference value generating devices 624 and 625. The predetermined pixel value generating device 621 is disposed for finding the predetermined pixel value “b” corresponding to the received previous pixel value (X−1) from the session F1 of the over-drive table 300. The predetermined pixel value generating device 622 is disposed for finding the predetermined pixel value F2₍ₐ₋₎ corresponding to the received current pixel value X from the session F2 of the over-drive table 300. The predetermined pixel value generating device 623 is disposed for finding the predetermined pixel value F2₍ₐ₊₎ corresponding to the received current pixel value X from the session F2 of the over-drive table 300. The predetermined pixel value F2₍ₐ₋₎ is the closest value to the received current pixel value X less than the received current pixel value X, and the predetermined pixel value F2₍ₐ₊₎ is the closest value to the received current pixel value X greater than the received current pixel value X. The sub-reference value generating device 624 is disposed for generating the reference over-drive value OD_{(b,a-)} according to the predetermined value “b” and the predetermined pixel value F2₍ₐ₋₎. The sub-reference value generating device 625 is disposed for generating the reference over-drive value OD_{(b,a+)} according to the predetermined value “b” and the predetermined pixel value F2₍ₐ₊₎.

The weighted value generating device 630 is coupled to the storing device 61 0 for finding the corresponding weighted values P₁ and P₂ according to the received current pixel value X and the equations (1) and (2) from the predetermined weighted value table 400.

The calculating device 640 is coupled to the reference value generating device 620 and the weighted value generating device 630. The calculating device 640 receives the reference over-drive values OD_{(b,a-)} and OD_{(b,a+)}, and the weighted values P₁ and P₂, and generates the desired over-drive value OD_{(b,a)}.

To sum up, the method and device for generating over-drive data provided by the present invention effectively reduce the size of the over-drive table while maintaining the quality of the displayed frame, which increases convenience.

Those skilled in the art will readily observe that numerous modifications and alterations of the device and method may be made while retaining the teachings of the invention.

What is claimed is:

1. A method for generating over-drive data, the method comprising:
(a) storing a reduced over-drive table and a predetermined weighted table;
(b) finding a first reference value and a second reference value from the reduced over-drive table according to a previous pixel value and a current pixel value;
(c) finding a first weighted value and a second weighted value from the predetermined weighted table according to the current pixel value; and
(d) generating the over-drive data according to the first reference value, the second reference value, the first weighted value, and the second weighted vale.

2. The method of claim 1, wherein the over-drive data is generated according to an equation: OD=(R1×P1)+(R2×P2), and OD represents the over-drive data, R1 represents the first reference value, P1 represents the first weighted value, R2 represents the second reference value, and P2 represents the second weighted value.

3. The method of claim 2, wherein the reduced over-drive table comprises an array constructed by a first set of predetermined pixel values and a second set of predetermined pixel values, and the step (b) comprises:
(e) finding a third predetermined pixel value corresponding to the previous pixel value from the first set of the predetermined pixel values;
(f) finding a fourth predetermined pixel value corresponding to the current pixel value and a fifth predetermined pixel value corresponding to the current pixel value from the second set of the predetermined pixel values;
(g) generating the first reference value according to the third predetermined pixel value and the fourth predetermined pixel value; and
(h) generating the second reference value according to the third predetermined pixel value and the fifth predetermined pixel value.

4. The method of claim 3, wherein in the step (c), the first weighted value and the second weighted value are found from the predetermined weighted table according to a difference between the current pixel value and the fourth predetermined pixel value.

5. The method of claim 4, wherein the first weighted value is generated by a first equation: P1=(C−PR4)/(PR5−PR4), and P1 represents the first weighted value, C represents the current pixel value, PR4 represents the fourth predetermined pixel value, and PR5 represents the fifth predetermined value; and the second weighted value is generated by a second equation: P2=(PR5−C)/(PR5−PR4), and P2 represents the second weighted value.

6. A generating device for generating over-drive data according to a previous pixel value and a current pixel value, the generating device comprising:
a storing device for storing a reduced over-drive table and a predetermined weighted table;
a reference value generating device coupled to the storing device for finding a first reference value and a second reference value from the reduced over-drive table according to the previous pixel value and the current pixel value;
a weighted value generating device coupled to the storing device for finding a first weighted value and a second weighted value from the predetermined weighted table according to the current pixel value; and
a calculating device coupled to the reference value generating device and the weighted value generating device for generating the over-drive data according to the first reference value, the second reference value, the first weighted value, and the second weighted value.

7. The generating device of claim 6, wherein the over-drive data is generated according to an equation: OD=(R1×P1)+(R2×P2), and OD represents the over-drive data, R1 represents the first reference value, P1 represents the first weighted value, R2 represents the second reference value, and P2 represents the second weighted value.

8. The generating device of claim 7, wherein the reduced over-drive table comprises an array constructed by a first set of predetermined pixel values and a second set of predetermined pixel values.

9. The generating device of claim 8, wherein the reference value generating device comprises:
a third predetermined pixel value generating device for finding a third predetermined pixel value corresponding to the previous pixel value from the first set of the predetermined pixel values;
a fourth predetermined pixel value generating device for finding a fourth predetermined pixel value corresponding to the current pixel value from the second set of the predetermined pixel values;
a fifth predetermined pixel value generating device for finding a fifth predetermined pixel value corresponding to the current pixel value from the second set of the predetermined pixel values;
a first sub-reference value generating device for generating the first reference value according to the third predetermined pixel value and the fourth predetermined pixel value; and
a second sub-reference value generating device for generating the second reference value according to the third predetermined pixel value and the fifth predetermined pixel value.

10. The generating device of claim 9, wherein the weighted value generating device finds the first weighted value and the second weighted value from the predetermined weighted table according to a difference between the current pixel value and the fourth predetermined pixel value.

11. The generating device of claim 10, wherein the first weighted value is generated by a first equation: P1=(C−PR4)/(PR5−PR4), and P1 represents the first weighted value, C represents the current pixel value, PR4 represents the fourth predetermined pixel value, and PR5 represents the fifth predetermined value; and the second weighted value is generated by a second equation: P2=(PR5−C)/(PR5−PR4), and P2 represents the second weighted value.
